(19) United States
(12) Patent Application Publication
(10) Pub. No.: US 2021/0188616 A1
(43) Pub. Date: Jun. 24, 2021

(54) SYSTEM AND METHOD FOR FLUID DELIVERY AT A TEMPORARY SITE

(71) Applicant: Fuel Automation Station, LLC, Birmingham, MI (US)

(72) Inventor: Ricky Dean Shock, Victoria, TX (US)

(21) Appl. No.: 16/723,030

(22) Filed: Dec. 20, 2019

(51) Int. Cl. B67D 7/08; B67D 7/00; B67D 7/04; B67D 7/20; B67D 7/22; B67D 7/36; B67D 7/38; B67D 7/62; B67D 7/78

(52) U.S. Cl. CPC B67D 7/08; B67D 7/00; B67D 7/04; B67D 7/20; B67D 7/78; B67D 7/36; B67D 7/38; B67D 7/62; B67D 7/224

(57) ABSTRACT

A fluid distribution system according to an example of the present disclosure includes a mobile trailer including a manifold having a plurality of outlets, and a plurality of sub-manifolds, each sub-manifold being configured to receive fluid from a respective one of the outlets and to provide the fluid to a respective plurality of supply lines. Each supply line has a control valve configured to control fluid flow in the supply line and a turbine meter configured to measure an amount of fluid flow through the supply line. A method of delivering fluid is also disclosed.

### BACKGROUND

This application relates to fluid delivery, and more particularly to a system and method for fluid delivery at a temporary site.

Fluid delivery at temporary sites can present challenges, because infrastructure present at permanent fluid delivery locations may not be present.

### SUMMARY

A fluid distribution system according to an example of the present disclosure includes a mobile trailer including a manifold having a plurality of outlets, and a plurality of sub-manifolds, each sub-manifold being configured to receive fluid from a respective one of the outlets and to provide the fluid to a respective plurality of supply lines. Each supply line has a control valve configured to control fluid flow in the supply line and a turbine meter configured to measure an amount of fluid flow through the supply line.

In a further embodiment of any of the foregoing embodiments, a controller is operable to adjust the control valves based on one or more trigger conditions.

In a further embodiment of any of the foregoing embodiments, the controller is configured to open a particular one of the control valves in response to a first trigger condition, and the controller is configured to close the particular control valve in response to a second trigger condition that is different from the first trigger condition.

In a further embodiment of any of the foregoing embodiments, at least one point of sale device is provided, the first trigger condition corresponds to receipt of customer information from the point of sale device associated with a particular supply line associated with the particular control valve, and the second trigger condition corresponds to detection by the turbine meter of the particular supply line that fluid flow in the supply line has ceased.

In a further embodiment of any of the foregoing embodiments, the first trigger condition corresponds to detection of a first fluid level in a storage tank associated with the particular control valve, and the second trigger condition corresponds to detection of a second fluid level in the storage tank, the second level being greater than the first level.

In a further embodiment of any of the foregoing embodiments, a pump is configured to pump the fluid from a fluid source through the manifold into the sub-manifolds in conjunction with the controller opening of one of the control valves.

In a further embodiment of any of the foregoing embodiments, the controller is configured to obtain meter readings from the turbine meters.

In a further embodiment of any of the foregoing embodiments, the controller is configured to create a log that tracks an amount of fluid dispensed through the supply lines based on the meter readings.

In a further embodiment of any of the foregoing embodiments, the control valves are pneumatic valves.

In a further embodiment of any of the foregoing embodiments, the control valves are manual valves or electric valves or hydraulic valves.

In a further embodiment of any of the foregoing embodiments, for each of the supply lines, a hose is provided downstream of the turbine meter for dispensing fluid from the supply line, and the hose is wound around a hose reel.

In a further embodiment of any of the foregoing embodiments, each of the plurality of sub-manifolds are provided along one or more outer edges of the mobile trailer.

In a further embodiment of any of the foregoing embodiments, the plurality of sub-manifolds are arranged such that at least a portion of each of the plurality of supply lines are substantially parallel to each other.

In a further embodiment of any of the foregoing embodiments, each supply line has a first portion that has a respective one of the turbine meters and a second portion that has a fuel dispensing outlet, and the first and second portions are substantially perpendicular to each other.

A method of delivering fluid according to an example of the present disclosure includes transporting a trailer to a temporary fluid delivery site, and delivering fluid from the trailer to fluid vessels at the temporary fluid delivery site. The delivering includes pumping fluid from a fuel manifold to a plurality of supply lines of a sub-manifold, each supply line including a control valve and a turbine meter, operating the control valves to control fluid delivery through the supply lines, and determining an amount of fluid delivered through the supply lines based on signaling from turbine meters, each turbine meter associated with a particular one of the supply lines.

In a further embodiment of any of the foregoing embodiments, each supply line has an output connected to a hose, and said delivering fuel from the trailer to fluid vessels at the site includes pumping the fuel through the hoses to the fluid vessels.

In a further embodiment of any of the foregoing embodiments, operating the control valves includes adjusting individual ones of the control valves based on one or more trigger conditions, and pumping fluid is initiated in response to the one or more trigger conditions.

In a further embodiment of any of the foregoing embodiments, adjusting individual ones of the control valves includes opening one of the control valves in response to a first trigger condition, and closing the one of the control valves in response to a second trigger condition that is different than the first trigger condition.

In a further embodiment of any of the foregoing embodiments, delivering fluid from the trailer to fluid vessels includes delivering water to the fluid vessels.

In a further embodiment of any of the foregoing embodiments, delivering fluid from the trailer to fluid vessels at the temporary fluid delivery site includes delivering fuel to fuel tanks of equipment.

In a further embodiment of any of the foregoing embodiments, the temporary fluid delivery site is a well site, and the delivering of fuel includes delivering fuel to hydraulic fracturing equipment at the well site.

In a further embodiment of any of the foregoing embodiments, the control valves are pneumatic vales, and operating the control valves to control fluid delivery through the supply lines includes delivering pressure to the pneumatic valves to control fluid delivery through the supply lines.

In a further embodiment of any of the foregoing embodiments, the control valves are electric valves, and operating the control valves to control fluid delivery through the supply lines includes delivering electrical signals to the electric valves to control fluid delivery through the supply lines.

In a further embodiment of any of the foregoing embodiments, the control valves are hydraulic valves, and operating the control valves to control fluid delivery through the supply lines comprises delivering pressurized hydraulic fluid to the hydraulic valves to control fluid delivery through the supply lines.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

FIG. 1 illustrates an example mobile fluid distribution system for distributing fluid at a temporary site.

FIG. 2 illustrates an example internal layout of the system of FIG. 1.

FIG. 3 illustrates an isolated view of example manifold and example sub-manifold assemblies that can be used in the system of FIG. 1.

FIG. 4 illustrates an example turbine meter that can be used in the sub-manifold assemblies of FIG. 3.

FIG. 5 illustrates another view of one of the sub-manifold assemblies of FIG. 3.

### DETAILED DESCRIPTION

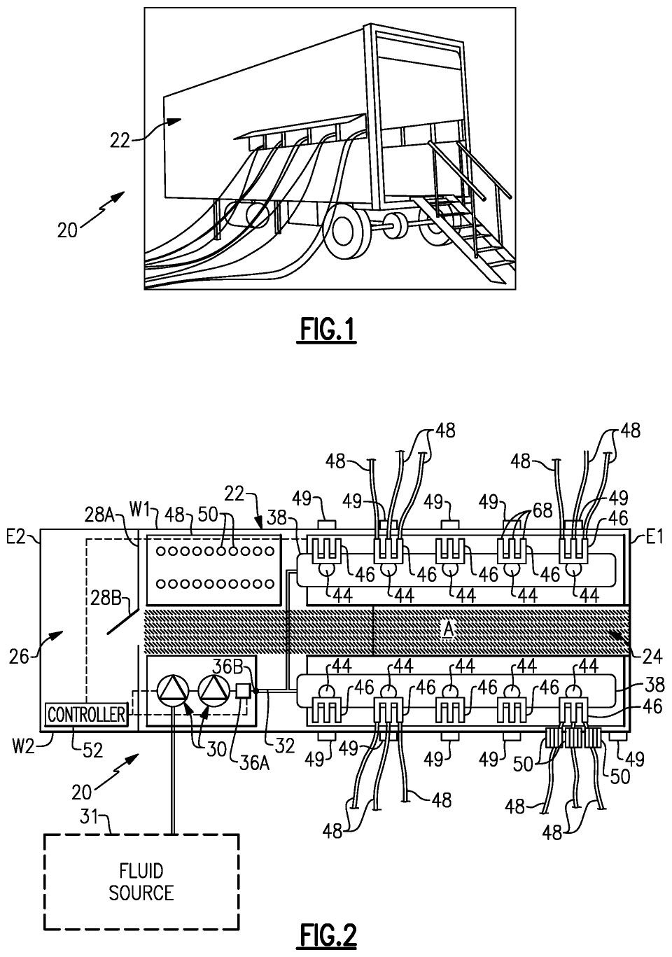

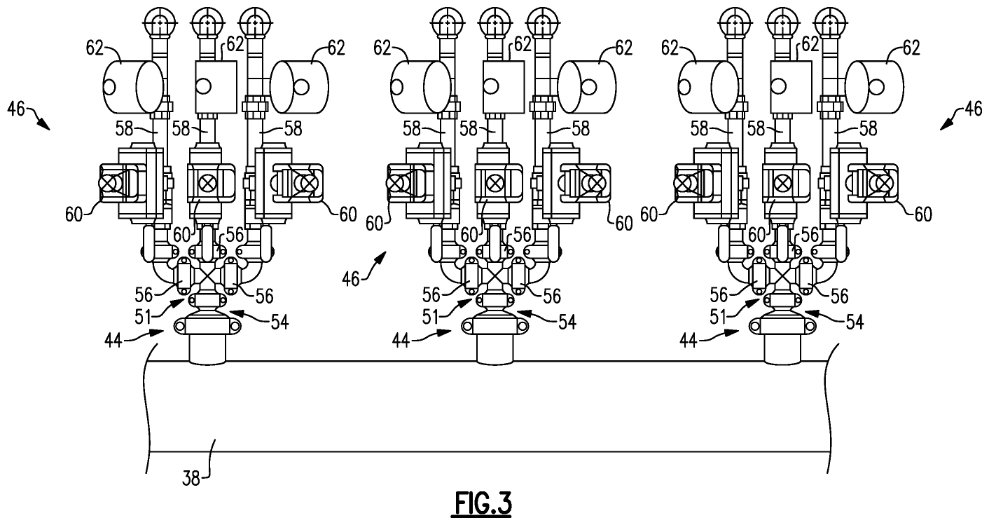

FIG. 1 illustrates an example mobile fluid distribution system 20 and FIG. 2 illustrates an example internal layout of the system 20. As will be described, the system 20 may be utilized to dispense a variety of fluids at a temporary fluid delivery site. For example, the system 20 could be used to deliver water in an emergency services capacity for a community (e.g., in the event of a natural disaster), or could be used to distribute fuel to vehicles and/or in a “hot-refueling” capacity to multiple pieces of equipment while the equipment is running, such as electric generators or hydraulic fracturing equipment at a well site. Temporary sites such as these, which may need fluid delivery for only matter of days or weeks or months, may be located in remote areas, and may lack the permanent infrastructure that is present at non-temporary sites. Due to their temporary nature, it may not be feasible to build such permanent infrastructure at such sites. Due to its mobility, the system 20 is suitable for delivering fluid at such temporary sites. As will be appreciated, the examples above are non-limiting examples, and it is understood that the system 20 could be used for dispensing other fluids and/or at other temporary sites.

In the depicted example, the system 20 includes a mobile trailer 22. It is to be understood, however, that the system 20 may alternatively be in a vehicle. Generally, the mobile trailer 22 is elongated and has first and second opposed trailer side walls W1 and W2 that join first and second opposed trailer end walls E1 and E2. Most typically, the trailer 22 will also have a closed top (not shown). The mobile trailer 22 may have wheels that permit the mobile trailer 22 to be moved by a vehicle from site to site to service different operations. In the depicted example, the mobile trailer 22 has two compartments. A first compartment 24 includes the physical components for distributing a fluid, such as water or diesel fuel, and a second compartment 26 serves as an isolated control room for managing and monitoring fluid distribution. The compartments 24/26 are separated by an inside wall 28A that has an inside door 28B. If integrated into a vehicle, the same or a similar arrangement may be used, but with a truck cab and engine.

The first compartment 24 includes one or more pumps 30. Fluid may be provided to the one or more pumps 30 from an external fluid source 31, such as a tanker truck on the site. On the trailer 22, the one or more pumps 30 are configured to pump fluid from the fluid source 31 into a fluid line 32, which may include, but is not limited to, hard piping. The fluid line 32 may include a filtration and air eliminator system 36A and one or more sensors 36B. Although optional, the system 36A is beneficial in many implementations, to remove foreign particles and air from the fluid prior to delivery. The one or more sensors 36B may include a temperature sensor, a pressure sensor, or a combination thereof, which assist in fluid distribution management.

The fluid line 32 is connected with one or more manifolds 38. In the illustrated example, the system 20 includes two manifolds 38 that are arranged on opposed sides of the compartment 24. As an example, the manifolds 38 are elongated tubes that are generally larger in diameter than the fluid line 32 and that have at least one inlet and multiple outlets 44. A sub-manifold assembly 46 is connected to each outlet 44, and provides branched supply lines to which hoses 48 can be connected for dispensing fluid therefrom. As shown in the example of FIG. 2, the sub-manifold assemblies 46 can be arranged along the outer edges of the mobile trailer 22 at side walls W1 and W2.

The sub-manifold assemblies 46 provide for convenient attachments of many hoses 48 to the manifolds 38, and, as will be described below in greater detail, convenient control of fluid delivery through the attached hoses 48, and convenient monitoring of fluid dispensed into the hoses. The sub-manifold assemblies 46 also provide for independent data capture of fuel dispensing through the various outputs 68 of the supply lines, which enables charging for fluid dispensing by fluid type and customer.

Although FIG. 2 depicts the compartment 24 as including an aisle way and manifolds 38 on either side of the aisle way, this is a non-limiting example and other configurations could be used.

Also, although FIG. 2 only shows twelve hoses 48 as being attached to the trailer 22, each depicted sub-manifold assembly 46 in the example of FIG. 2 has three outputs 68, and there are ten sub-manifold assemblies 46 depicted, so thirty hoses 48 could be attached in FIG. 2. Other quantities of hoses 48 could be attached in other arrangements (e.g., with more or fewer sub-manifold assemblies 46 and/or more or fewer outputs at each sub-manifold assembly 46).

The hoses 48 may be wound around reels 50 that are rotatable to extend or retract their respective hose 48. Each reel 50 may have an associated motor to mechanically extend and retract the hose 48. Although only three reels 50 are illustrated in FIG. 2, it is understood that other quantities of reels 50 could be utilized (e.g., every hose 48 having a reel 50, or the reels 50 being excluded entirely), and it is also understood that the reels 50 could be located inside of the compartment 24 if desired. In one example, the trailer 22 is arranged such that some or all of the hoses 48 extend through one or more windows of the trailer 22.

Hoses 48 of different lengths could be used for different applications. For example, dispensing water into containers at an emergency services site may utilize a shorter hose 48 than a refueling application where vehicles or other fuel-consuming equipment are being refueled.

In the example of FIG. 2, a plurality of point of sale (POS) devices 49 are provided, each being associated with one of the sub-manifold assemblies 46. Each POS device 49 is in communication with the controller 52 and is operable to provide information, such as payment information, from a user in conjunction with a request to initiate fluid dispending through an outlet of its associated sub-manifold assembly 46. The POS devices 49 may include a credit card reader for reading credit cards, an electronic display, and a user interface (e.g., a touchscreen), for example.

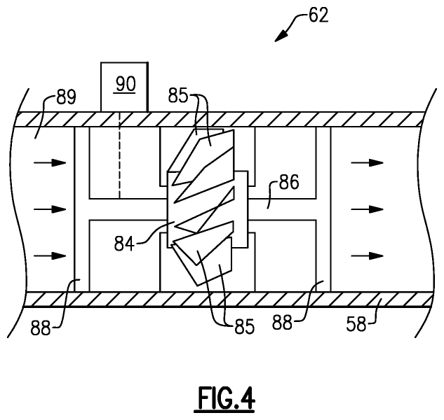

FIG. 3 illustrates an isolated view of a plurality of the sub-manifold assemblies 46. As shown in FIG. 3, each sub-manifold assembly 46 includes a sub-manifold 51 having an input 54 connected to an output 44 of the manifold 38 for receiving fluid, and having a plurality of outlets 56 for dispensing fluid to a plurality of supply lines 58. In the example of FIG. 3, the plurality of supply lines 58 are substantially parallel to each other.

Each supply line 58 includes a control valve 60 configured to control fluid flow in the supply line 58, and a turbine meter 62 configured to measure fluid flow through the supply line 58. In the example of FIG. 3, each turbine meter 62 is downstream of the control valve 60 of its respective supply line 58. Alternatively, this order could switched such that each turbine meter 62 is upstream of its associated control valve 60. In examples, the control valves 60 are pneumatic valves controlled by pressure from an air compressor (not shown), electric valves controlled by electrical signaling, hydraulic valves controlled by pressurized hydraulic fluid, or manual valves.

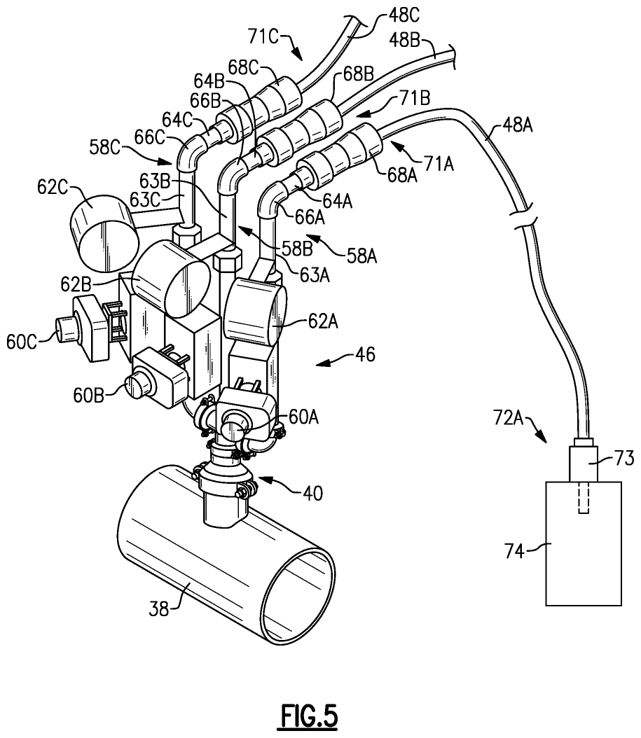

FIG. 4 schematically illustrates an example implementation of the turbine meter 62. As shown in FIG. 5, the turbine meter 62 includes a rotor 84 that corotates with an axle 86. The rotor 84 includes a plurality of rotor blades 85 that extend radially outward from the rotor 84. The axle 86 is supported by supports 88.

The rotor 84 is set in the path of a fluid stream 89 of its corresponding supply line 58. The flowing fluid in the fluid stream 89 impinges the rotor blades 85, which imparts a force to the blade surface and causing rotation of the rotor 84. When a steady rotation speed has been reached, the speed is proportional to fluid velocity.

The turbine meter 62 translates the mechanical action of the rotor 84 rotation into a user-readable rate of flow (e.g., gallons per minute, liters per minute, etc.). A transmitter 90 is provided for transmitting meter readings to the controller 52. The transmitter 90 could be configured for wired and/or wireless data transmission.

FIG. 5 illustrates a perspective view of one of the sub-manifold assemblies 46 which includes supply lines 58A-C. As shown, each supply line 58A-C includes a respective first portion 63A-C and second portion 64A-C joined by a respective elbow 66A-C. In the depicted example, the first portions 63A-C include the control valves 60A-C and turbine meters 62A-C, and the second portions 64A-C include respective fuel dispensing outlets 68A-C that can be connected to hoses 48A-C.

In one example, the first portion 63A-C and the second portion 64A-C of each supply line 58A-C are substantially perpendicular. In the same or another example, each first portion 63A-C associated with a particular manifold 38 are substantially parallel to each other, and each second portion 64 associated with a particular manifold 38 are also substantially parallel to each other.

Each hose 48 includes a first end 71 and an opposing second end 72. Although only a single second end 72A is shown in FIG. 4, it is understood that each hose 48 includes a second end 72. The depicted second end 72A includes a nozzle 73 inserted into a fluid vessel 74 for delivering fluid to the fluid vessel 74. The fluid vessel 74 could be a water container, a fuel tank, a fuel tank in a vehicle, etc. Of course, it is understood that other fluid vessels 74 could be used.

Although the nozzle 73 is depicted as being inserted into a top of the vessel 74, it is understood that alternate configurations could be used, such as where the nozzle 73 is inserted into a side of the vessel 74. Also, it is understood that the end 72A could vary, and could include a manual pump handle, a quick connect fitting, or some other end portion. In one example, one or both of the ends 71, 72 of the hoses 48 use quick-connect fittings.

Although each sub-manifold assembly 46 is depicted as having three supplies lines 58 and three corresponding outputs 68, it is understood that other quantities of supply lines 58 and corresponding outputs 68 could be provided (e.g., two supply lines 58 or four or more supply lines 58). Also, although FIG. 2 shows a single POS device 49 being shared by the multiple outputs 68 of each sub-manifold assembly 46, it is understood that additional POS devices 49 could be provided (e.g., one per output 68).

A controller 52 (FIG. 2) is in communication with each of the turbine meters 62 to obtain meter readings. The controller 52 is operable to create a log that tracks an amount of fluid dispensed through the supply lines 58 based on the meter readings from the turbine meters 62. Although only a single controller 52 is shown, a distributed architecture could be used in some examples in which multiple control units are used that are in communication with each other or a master controller.

The control valves 60, turbine meters 62, pump(s) 30, sensor(s) 36, and POS devices 49 are in communication with the controller 52, which may be located in the second compartment 26. The controller 52 includes processing circuitry configured to carry out any of the functions described herein. In one further example, the controller 52 includes a programmable logic controller with a touch-screen for user input and display of status data. For example, the screen may simultaneously show multiple fluid levels of the equipment to which fluid is being delivered. As another example, the screen may show which ones of the supply lines 58 are actively dispensing fluid.

In embodiments in which the control valve 60 is a non-manual valve (e.g., pneumatic or electric or hydraulic), the controller 52 is operable to adjust the control valves 60 based on one or more trigger conditions representative of a demand for fluid. In one example, the controller 52 responds to a first trigger condition (e.g., a signal from one of the POS devices 49) by opening a control valve 60 corresponding to the POS device 49, and response to a second trigger condition (e.g., fluid flow through a supply line 58 of the control valve ceasing) by turning off the control valve 60.

By utilizing the turbine meters 62, the controller 52 can determine how much fluid is dispensed from particular ones of the supply lines 58 and their corresponding sub-manifold assemblies 46. This could be useful for generating invoices and/or receipts for customers.

Consider an emergency services application in which the trailer 22 is used to dispense water and there may be many customers traveling to the trailer 22 for water with containers of various sizes. In one such example, the customers interact with the POS devices 49 to open the particular control valve 60 associated with the supply line 58 of their corresponding hose 48, and dispense water through the hose 48 using the nozzle 73. The controller 52 detects when the nozzle 73 is closed based on a reading from the turbine meter 62, and then correspondingly closes the control valve 60 and generates a record of how much fluid was dispensed by the customer. The controller 52 in some examples then charges the customer using information provided at the POS device 49 (e.g., credit card information). Thus, multiple users can dispense fluid from the hoses 48 of a single sub-manifold assembly 46 and can each be tracked and/or billed separately. The trailer 22 can be used to individually charge users for dispensing fluid while also being mobile.

Alternate tracking and billing arrangements could be possible too, such as if a municipality decided to pay for all of the water dispensed for its residents. In such a case, the controller 52 could track all of the water dispensed and then generate an invoice for the municipality.

The system 20 could also be used for dispensing other fluids, such as fuel, into the vessels 74, which could be fuel tanks. In one example, the trailer 22 operates as a mobile fueling station for dispensing fuel into vehicles.

In another example, the fluid vessel 74 is a fuel tank, and the trailer 22 is adapted for fueling equipment, such as electrical generators or hydraulic fracturing equipment (e.g., pumpers and blenders). In one such example, the ends 72 of the hoses 48 include a fuel cap fastener instead of a manual nozzle. A sensor (e.g., a fuel cap sensor, not shown) may be provided that to a fuel tank opening of each vessel 74 for determining a fluid level and transmitting a signal to the controller 52 so that the controller 52 can adjust the control valves 60 based on fuel levels. For example, in response to a fuel level that falls below a lower threshold (first trigger condition), the controller 52 opens the control valve 60 associated with the hose 48 to that fuel tank and activates the pump or pumps 30. The pump or pumps 30 provide fuel flow into the manifolds 38 and through the open control valve 60 such that fuel is provided through the respective hose 48 and fuel cap sensor into the fuel tank. The lower threshold may correspond to an empty fuel level of the fuel tank, but more typically the lower threshold will be a level above the empty level to reduce the potential that the equipment completely runs out of fuel and shuts down. Similarly, once the fuel level reaches an upper threshold (second trigger condition) that is greater than the lower threshold, the controller 52 stops the pump or pumps 30 and closes the control valve 60 that is dispensing fuel. In this “equipment” fueling scenario, the POS devices 49 may be omitted if desired, because it is likely that a single entity would be purchasing all dispensed fuel.

Although example embodiments have been disclosed, a worker of ordinary skill in this art would recognize that certain modifications would come within the scope of this disclosure. For that reason, the following claims should be studied to determine the scope and content of this disclosure.

1. A fluid distribution system comprising:
a mobile trailer including a manifold having a plurality of outlets, and a plurality of sub-manifolds, each sub-manifold being configured to receive fluid from a respective single one of the outlets and to provide the fluid to a respective plurality of supply lines;
wherein each supply line includes a control valve configured to control fluid flow in the supply line and a turbine meter configured to measure an amount of fluid flow through the supply line.

2. (canceled)

3. The fluid distribution system of claim 2, wherein:
a controller operable to adjust the control valves based on one or more trigger conditions;
wherein the controller is configured to open a particular one of the control valves in response to a first trigger condition; and
wherein the controller is configured to close the particular control valve in response to a second trigger condition that is different from the first trigger condition.

4. The fluid distribution system of claim 3, comprising at least one point of sale device, wherein:
the first trigger condition corresponds to receipt of customer information from the point of sale device associated with a particular supply line associated with the particular control valve; and
the second trigger condition corresponds to detection by the turbine meter of the particular supply line that fluid flow in the supply line has ceased.

5. The fluid distribution system of claim 3, wherein:
the first trigger condition corresponds to detection of a first fluid level in a storage tank associated with the particular control valve; and
the second trigger condition corresponds to detection of a second fluid level in the storage tank, the second level being greater than the first level.

6. The fluid distribution system of claim 2, comprising:
a pump configured to pump the fluid from a fluid source through the manifold into the sub-manifolds in conjunction with the controller opening one of the control valves.

7. The fluid distribution system of claim 2, comprising:
a controller operable to adjust the control valves based on one or more trigger conditions, wherein the controller is configured to obtain meter readings from the turbine meters.

8. The fluid distribution system of claim 7, wherein the controller is configured to create a log that tracks an amount of fluid dispensed through the supply lines based on the meter readings.

9. (canceled)

10. The fluid distribution system of claim 1, wherein the control valves are pneumatic valves, manual valves, electric valves or hydraulic valves.

11. The fluid distribution system of claim 1, wherein for each of the supply lines, a hose is provided downstream of the turbine meter for dispensing fluid from the supply line, and the hose is wound around a hose reel.

12. The fluid distribution system of claim 1, wherein each of the plurality of sub-manifolds are provided along one or more outer edges of the mobile trailer.

13. The fluid distribution system of claim 1, wherein the plurality of sub-manifolds are arranged such that at least a portion of each of the plurality of supply lines are substantially parallel to each other.

14. The fluid distribution system of claim 1, wherein each supply line includes a first portion that includes a respective one of the turbine meters and a second portion that includes a fuel dispensing outlet, and the first and second portions are substantially perpendicular to each other.

15. A method of delivering fluid comprising:
transporting a trailer to a temporary fluid delivery site; and
delivering fluid from the trailer to fluid vessels at the temporary fluid delivery site, said delivering including:
pumping fluid from a respective single one of a plurality of outlets of a fuel manifold to a plurality of supply lines of a sub-manifold, each supply line including a control valve and a turbine meter, said pumping comprising, for each sub-manifold, pumping the fluid to the sub-manifold from a respective single one of a plurality of outlets of the fuel manifold;
operating the control valves to control fluid delivery through the supply lines; and
determining an amount of fluid delivered through the supply lines based on signaling from turbine meters, each turbine meter associated with a particular one of the supply lines.

16. The method of claim 15, wherein each supply line has an output connected to a hose, and said delivering fluid from the trailer to fluid vessels at the site comprises:
pumping fuel through the hoses to the fluid vessels.

17. The method of claim 15, wherein:
said operating the control valves comprises adjusting individual ones of the control valves based on one or more trigger conditions; and
said pumping fluid is initiated in response to the one or more trigger conditions.

18. The method of claim 17, wherein said adjusting individual ones of the control valves comprises:
opening one of the control valves in response to a first trigger condition; and
closing said one of the control valves in response to a second trigger condition that is different than the first trigger condition.

19. The method of claim 15, wherein said delivering fluid from the trailer to fluid vessels comprises delivering water to the fluid vessels.

20. The method of claim 15, wherein said delivering fluid from the trailer to fluid vessels at the temporary fluid delivery site comprises delivering fuel to fuel tanks of equipment.

21. The method of claim 20, wherein said temporary fluid delivery site is a well site, and said delivering fuel comprises delivering fuel to hydraulic fracturing equipment at the well site.

22. The method of claim 15, wherein the control valves are pneumatic vales, and said operating the control valves to control fluid delivery through the supply lines comprises delivering pressure to the pneumatic valves to control fluid delivery through the supply lines.

23. The method of claim 15, wherein the control valves are electric valves, and said operating the control valves to control fluid delivery through the supply lines comprises delivering electrical signals to the electric valves to control fluid delivery through the supply lines.

24. The method of claim 15, wherein the control valves are hydraulic valves, and said operating the control valves to control fluid delivery through the supply lines comprises delivering pressurized hydraulic fluid to the hydraulic valves to control fluid delivery through the supply lines.

25. The fluid distribution system of claim 1, wherein each sub-manifold includes at least three supply lines.

26. The fluid distribution system of claim 1, wherein each supply line includes an input coupled to the submanifold, and an output for delivering fluid, and in each supply line the turbine meter is disposed between the control valve and the output.

27. The method of claim 15, wherein each sub-manifold includes at least three supply lines.

28. The method of claim 15, wherein each supply line includes an input coupled to the submanifold, and an output for delivering fluid, and in each supply line the turbine meter is disposed between the control valve and the output.
